(19) United States
(12) Patent Application Publication
(10) Pub. No.: US 2013/0198357 A1
(43) Pub. Date: Aug. 1, 2013

(54) DEVICE MANAGEMENT DEVICE, DEVICE MANAGEMENT SYSTEM AND COMPUTER PROGRAM PRODUCT

(71) Applicant: Weibo WANG, Kanagawa (JP)

(72) Inventor: Weibo WANG, Kanagawa (JP)

(21) Appl. No.: 13/751,687

(22) Filed: Jan. 28, 2013

(30) Foreign Application Priority Data
Jan. 31, 2012 (JP) 2012-018324
Dec. 7, 2012 (JP) 2012-268759

(51) Int. Cl. H04L 12/24

(52) U.S. Cl. CPC H04L 41/00
USPC 709/223

(57) ABSTRACT

A device management device connected to a first communication channel includes a transmitting unit that transmits a device information acquisition request via the first communication channel; a receiving unit that, when a device is connected to the first communication channel, receives a device information acquisition response containing device information of the device from the device via the first communication channel, whereas when the device is connected via a second communication channel to an information processing device connected to the first communication channel, receives a device information acquisition response containing device information of the device acquired by the information processing device from the information processing device via the first communication channel; and a managing unit that stores the device information received from the device and the device information received from the information processing device as device information of the identical device in a device information storage unit.

### CROSS-REFERENCE TO RELATED APPLICATIONS

The present application claims priority to and incorporates by reference the entire contents of Japanese Patent Application No. 2012-018324 filed in Japan on Jan. 31, 2012 and Japanese Patent Application No. 2012-268759 filed in Japan on Dec. 7, 2012.

### BACKGROUND OF THE INVENTION

1. Field of the Invention

The present invention relates to a device management device, a device management system, and a computer program product.

2. Description of the Related Art

Device management devices for managing devices connected via networks have been known. For example, Japanese Patent No. 3937478 discloses a technology for connecting managed devices to a network by using a network expansion board having agents in various protocols so that processing modules and the managed devices exchange management information by using these protocols.

Another example of such device management devices manages devices via an information processing device such as a personal computer (PC) to which the device management device is connected via a network and to which the devices are connected via communication interfaces such as universal serial bus (USB) cables.

With the technologies of the related art as described above, however, the device management devices manage a device as different devices when the connections thereof is different although the device is the same, and the device cannot therefore be managed continuously.

Therefore, there is a need for a device management device, a device management system and a computer program product capable of continuously managing devices even when the connections of the devices are switched.

### SUMMARY OF THE INVENTION

According to an embodiment, there is provided a device management device connected to a first communication channel. The device management device includes a transmitting unit that transmits a device information acquisition request via the first communication channel; a receiving unit that, when a device is connected to the first communication channel, receives a device information acquisition response containing device information of the device from the device via the first communication channel, whereas when the device is connected via a second communication channel to an information processing device connected to the first communication channel, receives a device information acquisition response containing device information of the device acquired by the information processing device from the information processing device via the first communication channel; and a managing unit that stores the device information of the device received from the device and the device information of the device received from the information processing device as device information of the identical device in a device information storage unit.

According to another embodiment, there is provided a device management system including a device management device and an information processing device that are connected to a first communication channel. The device management device includes a transmitting unit that transmits a first device information acquisition request via the first communication channel; a receiving unit that, when a device is connected to the first communication channel, receives a first device information acquisition response containing device information of the device from the device via the first communication channel, whereas when the device is connected via a second communication channel to the information processing device connected to the first communication channel, receives a first device information acquisition response containing device information of the device acquired by the information processing device from the information processing device via the first communication channel; and a managing unit that stores the device information of the device received from the device and the device information of the device received from the information processing device as device information of the identical device in a device information storage unit. The information processing device includes a control unit that, when the device is connected via the second communication channel, transmits a second device information acquisition request based on the first device information acquisition request to the device via the second communication channel, receives a second device information acquisition response containing the device information of the device from the device via the second communication channel, and transmits the first device information acquisition response based on the second device information acquisition response to the device management device via the first communication channel.

According to still another embodiment, there is provided a computer program product including a non-transitory computer-readable medium having a computer-readable program. The program causes a computer to execute transmitting a device information acquisition request via the first communication channel; receiving, when a device is connected to the first communication channel, a device information acquisition response containing device information of the device from the device via the first communication channel, whereas receiving, when the device is connected via a second communication channel to an information processing device connected to the first communication channel, a device information acquisition response containing device information of the device acquired by the information processing device from the information processing device via the first communication channel; and storing the device information of the device received from the device and the device information of the device received from the information processing device as device information of the identical device in a device information storage unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating an example of a configuration of a device management system according to an embodiment;

FIG. 2 is a block diagram illustrating an example of the configuration of the device management system according to the embodiment;

FIG. 3 is a block diagram illustrating an example of a configuration of a PC according to the embodiment;

FIG. 4 illustrates an example of a response in PJL according to the embodiment;

FIG. 5A illustrates an example of a response in PJL according to the embodiment;

FIG. 5B illustrates an example of a response in PJL according to the embodiment;

FIG. 6 is a block diagram illustrating an example of a configuration of a device according to the embodiment;

FIG. 7 is a block diagram illustrating an example of a configuration of a device management device according to the embodiment;

FIG. 8 is a table illustrating an example of device information stored in a device information storage unit by a managing unit according to the embodiment;

FIG. 9 is a table illustrating an example of the device information stored in the device information storage unit by the managing unit according to the embodiment;

FIG. 10 is a flowchart illustrating an example of processing performed by the PC at activation of a device when the device is connected to a communication interface in the device management system according to the embodiment

FIG. 11 is a flowchart illustrating an example of processing performed by the PC at occurrence of an error in a device when the device is connected to a communication interface in the device management system according to the embodiment;

FIG. 12 is a flowchart illustrating an example of processing performed by the PC when device information is requested by the device management device in the device management system according to the embodiment;

FIG. 13 is a flowchart illustrating an example of a registration process performed by the device management device in the device management system according to the embodiment;

FIG. 14 is a flowchart illustrating an example of a management process performed by the device management device in the device management system according to the embodiment;

FIG. 15 is a flowchart illustrating an example of a report creation process performed by the device management device in the device management system according to the embodiment;

FIG. 16 is a block diagram illustrating an example of a hardware configuration of the PC and the device management device according to the embodiment;

FIG. 17 is a block diagram illustrating an example of a configuration of a device according to a modified example;

FIG. 18 illustrates an example of a response in PJL according to the modified example;

FIG. 19 illustrates an example of a response in PJL according to the modified example;

FIG. 20 is a table illustrating an example of device information stored in a device information storage unit by a managing unit according to the modified example; and

FIG. 21 is a table illustrating an example of the device information stored in the device information storage unit by the managing unit according to the modified example.

### DETAILED DESCRIPTION OF THE PREFERRED EMBODIMENTS

An embodiment of a device management device, a device management system and a program therefor according to the present invention will be described in detail below with reference to the accompanying drawings.

First, a configuration of a device management system according to the embodiment will be described.

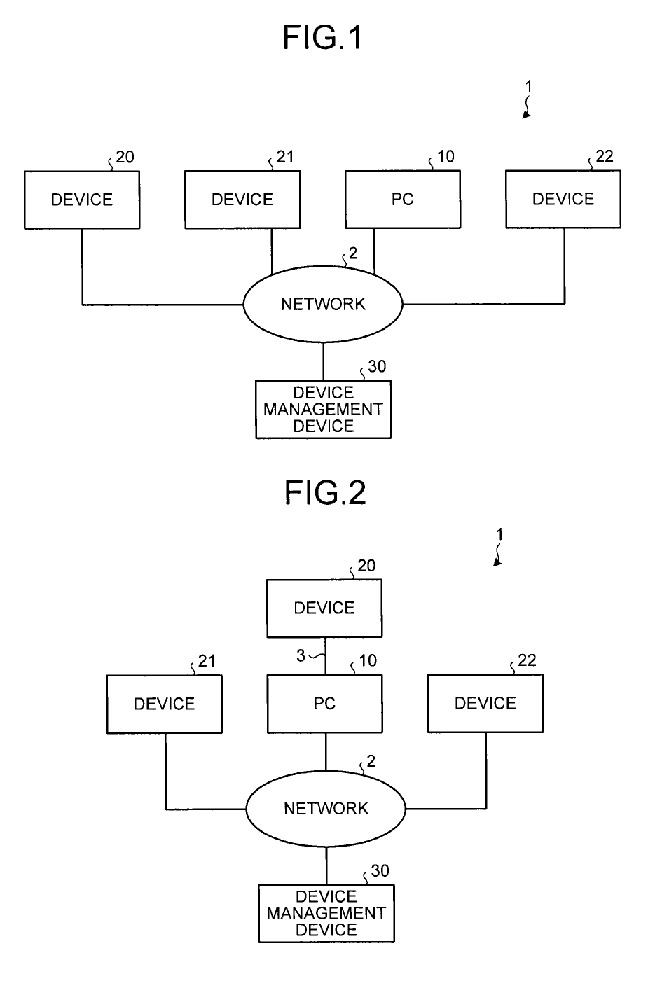

FIGS. 1 and 2 are block diagrams illustrating an example of the configuration of a device management system 1 according to the embodiment. As illustrated in FIG. 1, the device management system 1 includes a personal computer (PC) 10 (an example of an information processing device), devices 20 to 22, and a device management device 30.

The PC 10, the devices 21 and 22, and the device management device 30 are connected via a network 2 (an example of a first communication channel). The device 20 can be connected to the device management device 30 via the network 2 as illustrated in FIG. 1 or can be connected to the PC 10 via a communication interface 3 (an example of a second communication channel) as illustrated in FIG. 2. In other words, in the device management system 1 of the embodiment, at least the connection of the device 20 can be switched between network connection of connection to the network 2 and local connection of connection to the communication interface 3. The network 2 can be realized by the Internet or a local area network (LAN), for example. The communication interface 3 can be realized by a universal serial bus (USB) cable, for example.

The device management device 30 is provided in a service center of a service provider that provides device management services, and the PC 10 and the devices 20 to 22 are provided in service bases. A service base refers to an area where a device to be managed is located, such as an office of a company that receives device management services. Note that the location of the device management device 30 is not limited to the service center but may be a service base or the like.

The device management device 30 manages the PC 10 and the devices 20 to 22, and can be realized by a PC or the like in which device management (manager) programs, which will be described later, are installed. In FIGS. 1 and 2, the PC 10 and the devices 20 to 22 are illustrated as examples of the devices to be managed by the device management device 30, but the devices to be managed by the device management device 30 are not limited thereto.

The PC 10 has installed therein agent programs, which will be described later. When the device 20 is connected thereto via the communication interface 3 as illustrated in FIG. 2, upon receipt of a request to acquire device information from the device management device 30, the PC 10 acquires the device information from the device 20 via the communication interface 3, and informs the device management device 30 of the acquired information. In this manner, the device management device 30 can manage the device 20 even when the device 20 is not connected to the network 2.

The device 20 may be any device that can be connected to both of the communication interface 3 and the network 2, and the devices 21 and 22 may be any device that can be connected to at least the network 2. Note that the devices 21 and 22 may be devices that can be connected to both of the communication interface 3 and the network 2. Examples of the devices 20 to 22 include image forming devices such as printers, copiers, multifunction peripherals (MFPs), scanners, and facsimile devices, and various electronic devices such as projectors, cameras, air conditioners, refrigerators, fluorescent lights, vending machines, and handheld terminals. An MFP is a machine that has at least two of a copying function, a printing function, a scanning function and a facsimile function. In the embodiment, an example in which the devices 20 to 22 are printers will be described.

In the following description, a device connected to the network 2 may be referred to as a network device and a device connected to the communication interface 3 may be referred to as a local device.

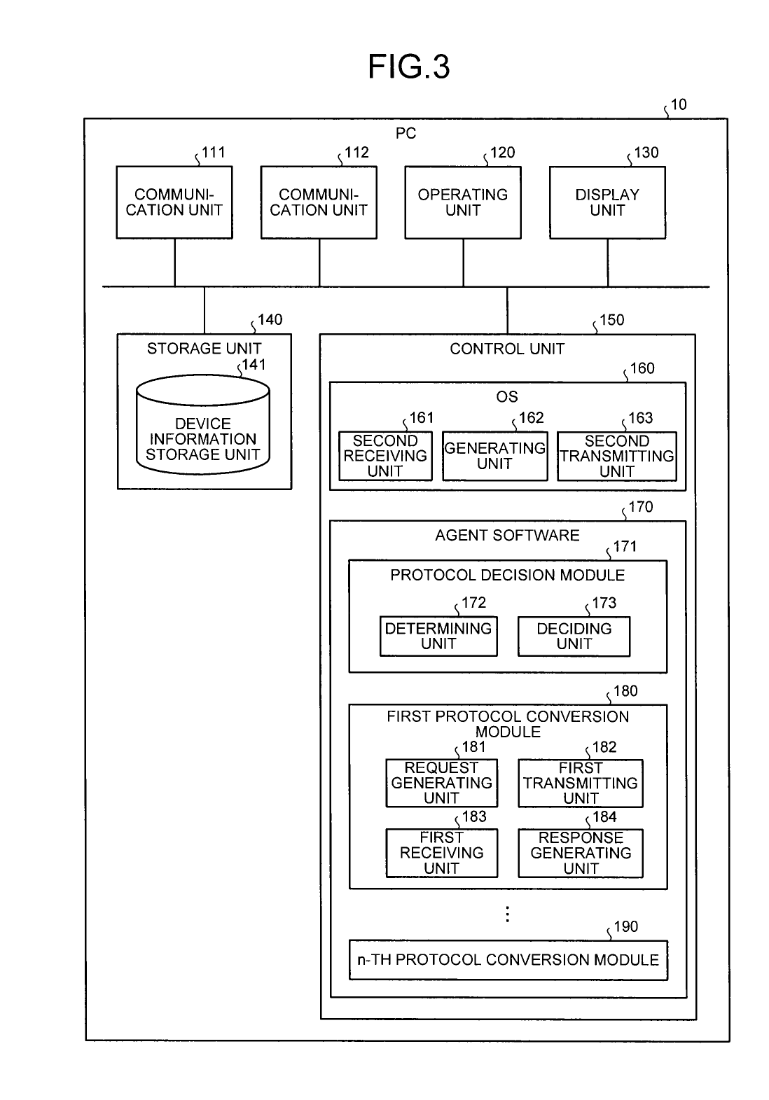

FIG. 3 is a block diagram illustrating an example of the configuration of the PC 10 according to the embodiment. As illustrated in FIG. 3, the PC 10 includes a communication unit 111, a communication unit 112, an operating unit 120, a display unit 130, a storage unit 140 and a control unit 150.

The communication unit 111 communicates with external devices such as the device management device 30 via the network 2, and can be realized by a network interface card (NIC), for example.

The communication unit 112 communicates with local devices such as the device 20 via the communication interface 3, and can be realized by a USB or the like.

The operating unit 120 performs various operation inputs, and can be realized by an input device such as a keyboard, a mouse, a touch pad, and a touch panel.

The display unit 130 displays various screens, and can be realized by a display device such as a liquid crystal display and a touch panel display.

The storage unit 140 stores various programs such as operating system (OS) programs and agent programs to be executed by the PC 10, and data used for various processes to be performed by the PC 10. The storage unit 140 can be realized by at least any of magnetically, optically or electrically recordable storage devices such as a hard disk drive (HDD), a solid state drive (SSD), a memory card, an optical disk, a read only memory (ROM), and a random access memory (RAM), for example.

The storage unit 140 includes a device information storage unit 141 that stores device information of the PC 10 itself and device information of local devices. The device information storage unit 141 stores the device information of the PC 10 in advance, and stores the device information of local devices as necessary by the control unit 150, which will be described later, when the local devices are connected. The device information of the PC 10 may be any information relating to the PC 10 such as a serial number, an IP address, an MAC address, a device name, a model name, administrator information and error information of the PC 10. The device information of a local device may be any information relating to the local device such as a serial number, an MAC address, a device name, a model name, count information, error information (call information), and tray information of the local device.

The control unit 150 controls respective units of the PC 10, and can be realized by a controller such as a central processing unit (CPU). The control unit 150 includes an OS 160 and agent software 170 (hereinafter referred to as agent software 170). Note that the control unit 150 implements the OS 160 and the agent software 170 by starting (executing) the OS programs and the agent programs, respectively, stored in the storage unit 140.

The OS 160 controls the respective units of the PC 10 (specifically, hardware and software of the PC 10), and can be realized by basic software such as Windows (registered trademark) and UNIX (registered trademark). The OS 160 includes a second receiving unit 161, a generating unit 162, and a second transmitting unit 163.

The second receiving unit 161 receives a device information acquisition request in a first protocol from the device management device 30 via the network 2. In the embodiment, an example in which the first protocol is the simple network management protocol (SNMP) will be described, but the first protocol is not limited thereto. The first protocol may be any protocol in which the device management device 30 can manage network devices, and may be the hyper text transfer protocol (HTTP) or the simple object access protocol (SOAP). The generating unit 162 and the second transmitting unit 163 will be described later.

The agent software 170 acquires device information from local devices, and includes a protocol decision module 171, and a first protocol conversion module 180 to an n-th (n is a natural number) protocol conversion module 190.

The protocol decision module 171 includes a determining unit 172 and a deciding unit 173.

The determining unit 172 determines whether or not to convert the protocol of a device information acquisition request in the first protocol received by the second receiving unit 161.

Specifically, the determining unit 172 checks whether or not a local device is connected to the PC 10 by using registry information, port information and the like of the storage unit 140, and if no local device is connected to the PC 10, the determining unit 172 determines not to convert the protocol of the device information acquisition request in the first protocol. If the device information requested to be acquired in the device information acquisition request in the first protocol is stored in the device information storage unit 141, the determining unit 172 determines not to convert the protocol of the device information acquisition request in the first protocol.

In the embodiment, the agent software 170 acquires device information with fixed values (that do not change) such as the serial number, the MAC address, the device name and the model name from a local device connected to the PC 10 and stores the acquired information in the device information storage unit 141 at activation of the local device. Thus, if the device information requested to be acquired in the device information acquisition request in the first protocol is fixed device information as described above, the determining unit 172 determines not to convert the protocol of the device information acquisition request in the first protocol since the device information is already stored in the device information storage unit 141.

In the embodiment, when an error occurs in a local device connected to the PC 10, the agent software 170 receives error information (call information) on the error that has occurred from the local device and stores the received information in the device information storage unit 141. Thus, if the device information requested to be acquired in the device information acquisition request in the first protocol is error information and if the error information is stored in the device information storage unit 141 and satisfies a predetermined condition, the determining unit 172 determines not to convert the protocol of the device information acquisition request in the first protocol. Note that the predetermined condition is, for example, whether or not a predetermined period has elapsed from a point when an error occurred until a point when the determining unit 172 performs determination, and it can be assumed that the predetermined condition is not satisfied if the predetermined period has elapsed while the predetermined condition is satisfied if the predetermined period has not elapsed.

On the other hand, if the local device is connected to the PC 10 and if the device information requested to be acquired in the device information acquisition request in the first protocol is not stored in the device information storage unit 141 or the device information is stored but the predetermined condition is not satisfied, the determining unit 172 determines to convert the protocol of the device information acquisition request in the first protocol.

For example, when the device information requested to be acquired in the device information acquisition request in the first protocol is count information or tray information, the determining unit 172 determines to convert the protocol of the device information acquisition request in the first protocol since the device information is not stored in the device information storage unit 141. For another example, when the device information requested to be acquired in the device information acquisition request in the first protocol is error information and if the predetermined condition is not satisfied even if the device information is stored in the device information storage unit 141, the determining unit 172 determines to convert the protocol of the device information acquisition request in the first protocol.

The deciding unit 173 decides a protocol into which the device information acquisition request in the first protocol received by the second receiving unit 161 is to be converted. Specifically, if it is determined by the determining unit 172 to convert the protocol of the device information acquisition request in the first protocol, the deciding unit 173 decides the protocol into which the device information acquisition request in the first protocol is to be converted by using the model name or the like of the local device stored in the device information storage unit 141.

In the embodiment, when the device 20 is connected to the PC 10 via the communication interface 3, the deciding unit 173 decides a second protocol as the protocol into which the device information acquisition request in the first protocol is to be converted by using the model name or the like of the device 20 stored in the device information storage unit 141. An example in which the second protocol is a predetermined printer job language (PJL) will be described herein, but the second protocol is not limited thereto. The protocol such as the second protocol into which the device information acquisition request in the first protocol is to be converted may be any protocol in which the PC 10 can manage local devices to be managed.

The first to n-th protocol conversion modules 180 to 190 are modules associated with protocols into which the device information acquisition request in the first protocol is to be converted. In the embodiment, it is assumed that the first protocol conversion module 180 is associated with the second protocol. Thus, description of the first protocol conversion module 180 out of the first to n-th protocol conversion modules 180 to 190 will mainly be provided herein. Note that the protocol conversion modules other than the first protocol conversion module 180 perform the same processing as the first protocol conversion module 180 although the protocols to be converted into are different therefrom.

The first protocol conversion module 180 includes a request generating unit 181, a first transmitting unit 182, a first receiving unit 183, and a response generating unit 184.

The request generating unit 181 generates a first device information acquisition request in the second protocol on the basis of the device information acquisition request in the first protocol transmitted from the device management device 30 via the network 2. Specifically, the request generating unit 181 generates the first device information acquisition request in the second protocol decided by the deciding unit 173 on the basis of the device information acquisition request in the first protocol received by the second receiving unit 161. The first device information acquisition request in the second protocol requests acquisition of count information of a local device, for example.

The request generating unit 181 also generates a second device information acquisition request in the second protocol at activation of a local device connected to the PC 10. The second device information acquisition request in the second protocol requests acquisition of fixed device information of a local device, for example.

The first transmitting unit 182 transmits the first device information acquisition request in the second protocol and the second device information acquisition request in the second protocol generated by the request generating unit 181 to a local device via the communication interface 3.

The first receiving unit 183 receives a first device information acquisition response in the second protocol and a second device information acquisition response in the second protocol containing the device information of the local device from a local device via the communication interface 3. The first device information acquisition response in the second protocol is a response to the first device information acquisition request in the second protocol, and the second device information acquisition response in the second protocol is a response to the second device information acquisition request in the second protocol.

The first receiving unit 183 also receives device information notification in the second protocol containing the device information of a device from a local device via the communication interface 3. The device information notification in the second protocol is to inform error information of a local device and contains error information as the device information of the local device, for example.

The response generating unit 184 converts the device information of a local device contained in the second device information acquisition request in the second protocol and the device information notification in the second protocol received by the first receiving unit 183 into those for the first protocol and stores the conversion result in the device information storage unit 141.

If it is determined by the determining unit 172 not to convert the protocol of the device information acquisition request in the first protocol, the response generating unit 184 generates a device information acquisition response in the first protocol by using the device information of local devices stored in the device information storage unit 141. If, however, it is determined by the determining unit 172 not to convert the protocol of the device information acquisition request in the first protocol because no local device is connected to the PC 10, the response generating unit 184 does not generate a device information acquisition response in the first protocol.

The response generating unit 184 also generates a device information acquisition response in the first protocol on the basis of the first device information acquisition response in the second protocol received by the first receiving unit 183. In this case, the response generating unit 184 may generate the device information acquisition response in the first protocol by using the device information of the PC 10 and the local device stored in the device information storage unit 141 in addition to the device information contained in the first device information acquisition response in the second protocol.

In the following, the description will be made assuming that device information of the local device contained in the device information acquisition response in the first protocol generated by the response generating unit 184 includes the IP address and the MAC address of the PC 10, and the serial number and status information such as count information and error information of the local device, but the device information is not limited thereto.

Here, processing of the first protocol conversion module 180 and the n-th protocol conversion module 190 will be described in the case of acquisition of tray information of a local device as an example. It is assumed that the first protocol conversion module 180 is a module associated with a predetermined PJL (second protocol) as described above and the n-th protocol conversion module 190 is a module associated with a PJL different from the predetermined PJL. Note that it is assumed here that local devices other than the device 20 are connected to the PC 10.

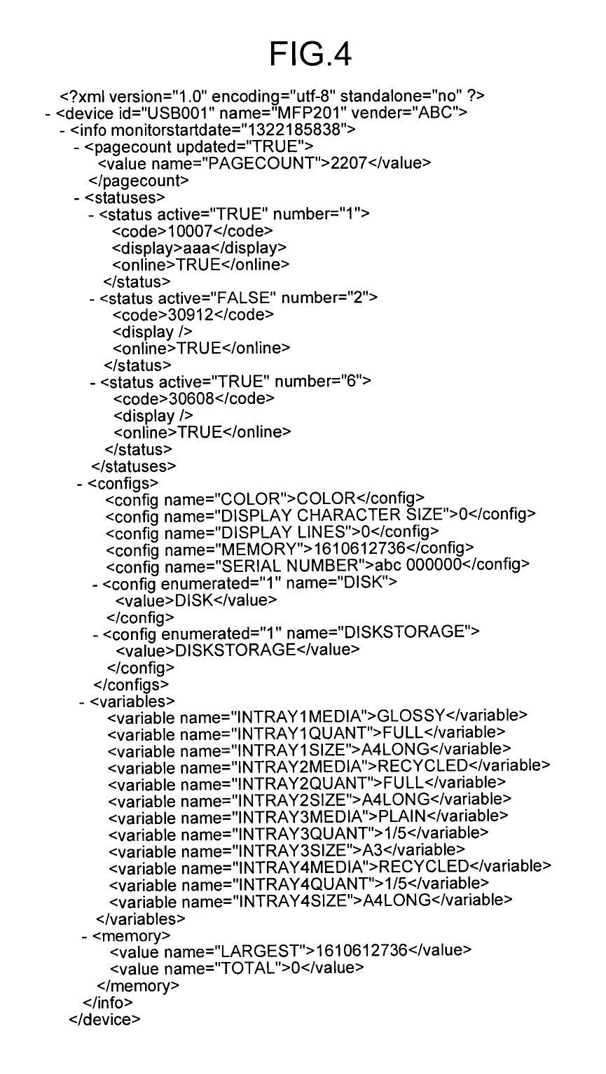

When the predetermined PJL is decided by the deciding unit 173 as the protocol into which the device information acquisition request in the first protocol is to be converted, the first protocol conversion module 180 generates @PJL INQUIRE INTRAYXSIZE, PJL INQUIRE INTRAYXQUANT, and @PJL INQUIRE INTRAYXMEDIA as the first device information acquisition request in the predetermined PJL, transmits the generated request to the device 20, receives a response from the device 20, formats the received response in XML data as illustrated in FIG. 4, parses data in a tab “variables” out of the formatted XML data, and converts the parsed data into those for the first protocol.

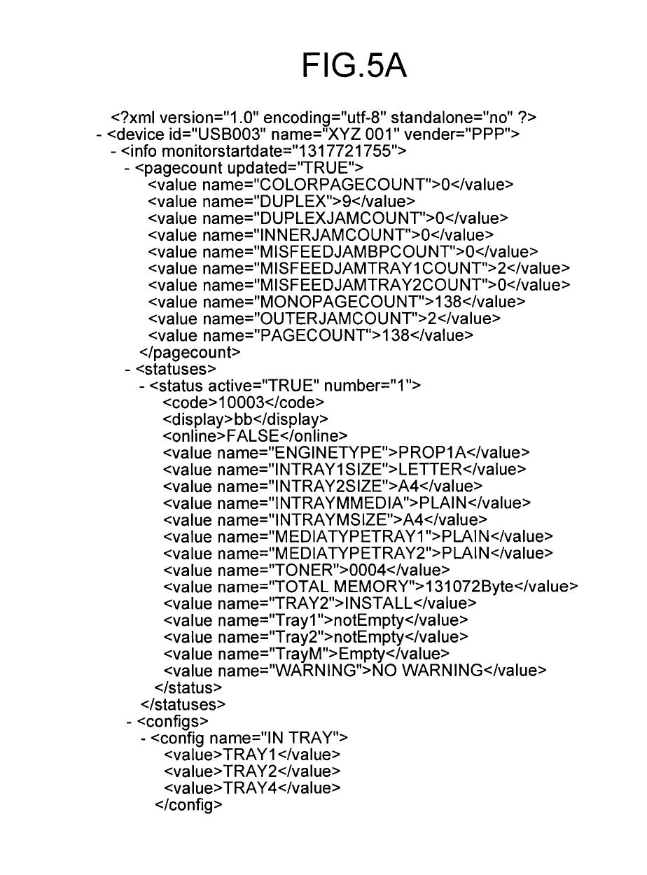

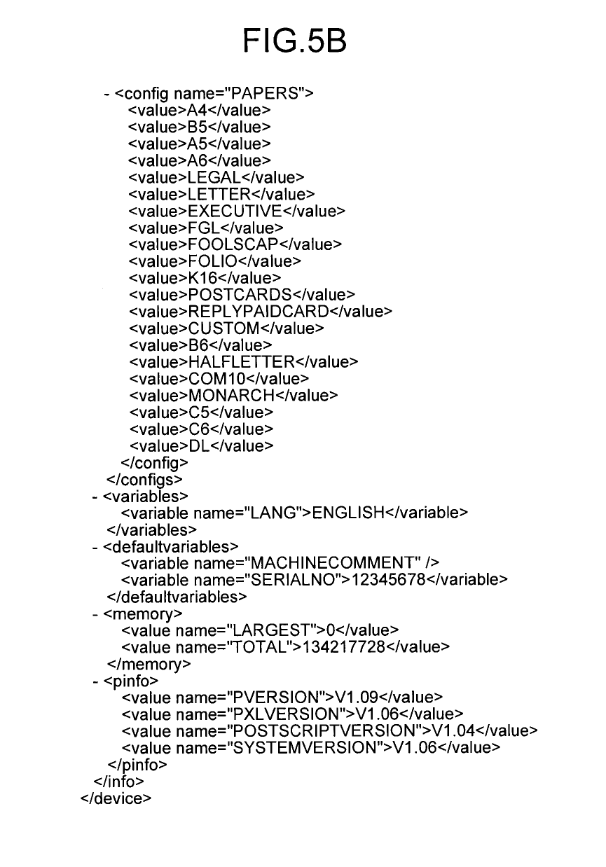

When the PJL different from the predetermined PJL is decided by the deciding unit 173 as the protocol into which the device information acquisition request in the first protocol is to be converted, the n-th protocol conversion module 190 generates @PJL INFO STATUS as the first device information acquisition request in the PJL, transmits the generated request to a local device that is different from the device 20 and connected to the PC 10, receives a response from the local device, formats the received response in XML data as illustrated in FIGS. 5A and 5B, parses data in a tab “statuses” out of the formatted XML data, and converts the parsed data into those for the first protocol.

Here, the generating unit 162 and the second transmitting unit 163 will be described.

The generating unit 162 generates a device information acquisition response in the first protocol in response to the device information acquisition request in the first protocol received by the second receiving unit 161 by using the device information of the PC 10 stored in the device information storage unit 141.

In the following, the description will be made assuming that the device information of the PC 10 contained in the device information acquisition response in the first protocol generated by the generating unit 162 includes the IP address, the MAC address and the serial number of the PC 10, but the device information is not limited thereto.

The second transmitting unit 163 transmits the device information acquisition response in the first protocol containing the device information of the local device generated by the response generating unit 184 and the device information acquisition response in the first protocol containing the device information of the PC 10 generated by the generating unit 162 to the device management device 30 via the network 2. When no local device is connected to the PC 10, however, the second transmitting unit 163 transmits the device information acquisition response in the first protocol containing the device information of the PC 10 generated by the generating unit 162 to the device management device 30 via the network 2 since the response generating unit 184 does not generate the device information acquisition response in the first protocol containing the device information of the local device.

The PC 10 need not include all of the respective units described above as essential components but some of the units may be excluded.

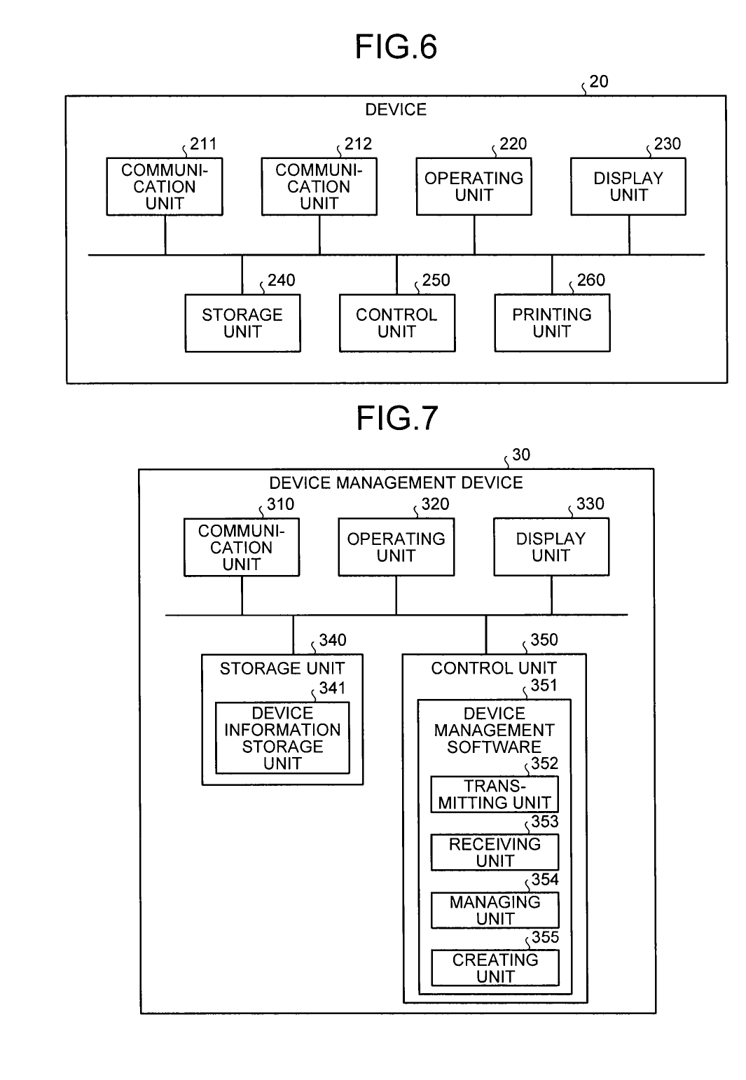

FIG. 6 is a block diagram illustrating an example of the configuration of the device 20 according to the embodiment. As illustrated in FIG. 6, the device 20 includes a communication unit 211, a communication unit 212, an operating unit 220, a display unit 230, a storage unit 240, a control unit 250, and a printing unit 260.

The communication unit 211 communicates with external devices such as the device management device 30 via the network 2, and can be realized by an NIC or the like.

The communication unit 212 communicates with the PC 10 via the communication interface 3, and can be realized by a USB or the like.

The operating unit 220 performs various operation inputs, and can be realized by an input device such as a key switch and a touch panel.

The display unit 230 displays various screens, and can be realized by a display device such as a liquid crystal display and a touch panel display.

The storage unit 240 stores various programs to be executed by the device 20 and data and the like such as the device information of the device 20 used for various processes to be performed by the device 20. The device information of the device 20 may be any information relating to the device 20 such as the serial number, the IP address, the MAC address, the device name, the model name, the count information, the error information (call information), and the tray information of the device 20. The IP address, however, is stored as the device information in the storage unit 240 when the device 20 is connected to the network 2, that is, when the device 20 is a network device.

The control unit 250 controls respective units of the device 20, and can be realized by a controller such as a CPU.

When the device 20 is connected to the network 2, upon receipt of the device information acquisition request in the first protocol from the device management device 30 via the network 2, the control unit 250 generates a device information acquisition response in the first protocol and transmits the generated response to the device management device 30 via the network 2. In the following, the description will be made assuming that the device information of the device 20 contained in the device information acquisition response in the first protocol generated by the control unit 250 includes the IP address, the MAC address, the serial number, and the status information such as count information and error information of the device 20, but the device information is not limited thereto. It is also assumed that the device information of the devices 21 and 22 contained in device information acquisition responses in the first protocol generated by the devices 21 and 22 also include the IP addresses, the MAC addresses, the serial numbers and the status information such as count information and error information of the devices 21 and 22.

When the device 20 is connected to the communication interface 3, upon receipt of a first device information acquisition request in the second protocol or a second device information acquisition request in the second protocol from the PC 10 via the communication interface 3, the control unit 250 generates a first device information acquisition response in the second protocol or a second device information acquisition response in the second protocol, and transmits the generated response to the PC 10 via the communication interface 3. If an error occurs in the device 20, the control unit 250 generates a device information notification in the second protocol and transmits the generated notification to the PC 10 via the communication interface 3.

The printing unit 260 performs printing when printing is requested in PJL by the PC 10.

FIG. 7 is a block diagram illustrating an example of the configuration of the device management device 30 according to the embodiment. As illustrated in FIG. 7, the device management device 30 includes a communication unit 310, an operating unit 320, a display unit 330, a storage unit 340, and a control unit 350.

The communication unit 310 communicates with network devices such as the PC 10 and the devices 20 to 22 via the network 2, and can be realized by an NIC or the like.

The operating unit 320 performs various operation inputs, and can be realized by an input device such as a keyboard, a mouse, a touch pad, and a touch panel.

The display unit 330 displays various screens, and can be realized by a display device such as a liquid crystal display and a touch panel display.

The storage unit 340 stores various programs such as device management programs to be executed by the device management device 30 and data used for various processes to be performed by the device management device 30. The storage unit 340 can be realized by at least any of magnetically, optically or electrically recordable storage devices such as an HDD, an SSD, a memory card, an optical disk, a ROM, and a RAM, for example. The storage unit 340 includes a device information storage unit 341 that stores device information of devices such as the PC 10 and the devices 20 to 22 to be managed by the device management device 30. Details of the device information storage unit 341 will be described later.

The control unit 350 controls respective units of the device management device 30, and can be realized by a controller such as a CPU. The control unit 350 includes device management software 351 (hereinafter referred to as the device management software 351). Note that the control unit 350 implements the device management software 351 as software by starting (executing) the device management programs stored in the storage unit 340. The device management software 351 also functions as a manager of the agent software 170 of the PC 10.

The device management software 351 manages the devices to be managed by the device management device 30 and includes a transmitting unit 352, a receiving unit 353, a managing unit 354 and a creating unit 355.

The transmitting unit 352 transmits a device information acquisition request in the first protocol to network devices via the network 2. In the present embodiment, an example in which the first protocol is the SNMP will be described, but the first protocol may be the HTTP, the SOAP or the like as described above.

The receiving unit 353 receives a device information acquisition response in the first protocol from a network device via the network 2. When the device 20 is a network device, the receiving unit 353 receives the device information acquisition response in the first protocol containing the device information of the device 20 from the device 20 via the network 2. When the device 20 is a local device and connected to the PC 10 via the communication interface 3, on the other hand, the receiving unit 353 receives the device information acquisition response in the first protocol containing the device information of the device 20 in addition to the device information acquisition response in the first protocol containing the device information of the PC 10 from the PC 10 via the network 2.

The managing unit 354 stores the device information contained in a device information acquisition response in the first protocol received from a network device via the network 2 in the device information storage unit 341, and manages the devices to be managed by the device management device 30. In this case, the managing unit 354 stores the device information of the device 20 received from the device 20 when the device 20 is a network device and the device information of the device 20 received from the PC 10 when the device 20 is a local device as device information of the same device in the device information storage unit 341. In other words, the managing unit 354 manages a device as the same device, not as different devices, even if the connection of the device to be managed is switched from network connection to local connection or from local connection to network connection.

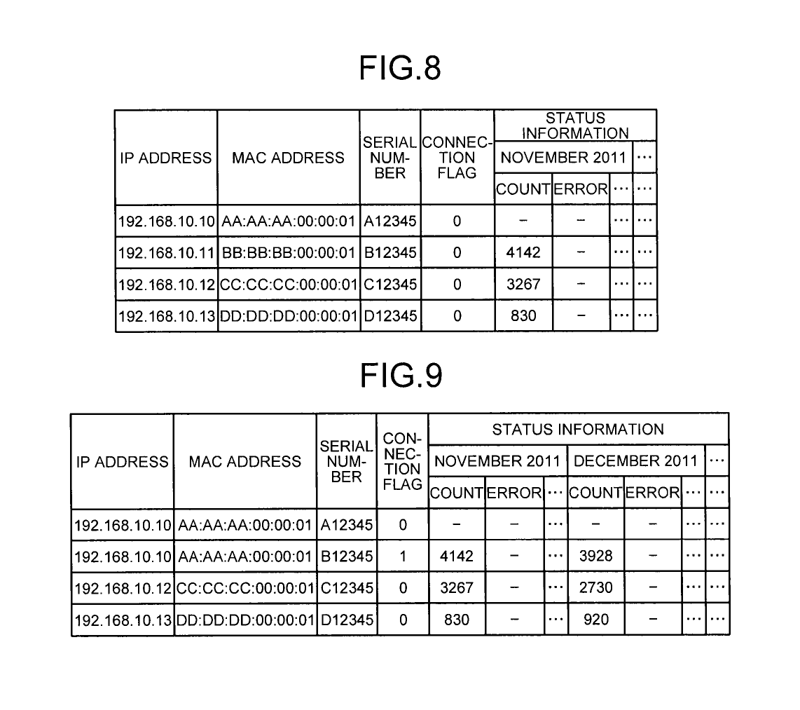

FIGS. 8 and 9 are tables illustrating examples of the device information stored in the device information storage unit 341 by the managing unit 354 of the embodiment. FIG. 8 illustrates the device information of devices under the connection as in FIG. 1, and FIG. 9 illustrates the device information of devices after the connection is switched from the connection as in FIG. 1 to the connection as in FIG. 2.

As illustrated in FIGS. 8 and 9, the device information stored in the device information storage unit 341 includes IP addresses, MAC addresses, serial numbers, connection flags and status information. It is assumed herein that the device information (serial number “A12345”, etc.) on the first line in FIGS. 8 and 9 represents information on the PC 10, the device information (serial number “B12345”, etc.) on the second line therein represents information on the device 20, the device information (serial number “C12345”, etc.) on the third line therein represents information on the device 21, and the device information on the fourth line (serial number “D12345”, etc.) therein represents information on the device 22. The connection flag (an example of connection information) is information representing the connection of a device, and “0” represents network connection while “1” represents local connection.

In FIG. 1, since the connection of the device 20 is network connection, when the transmitting unit 352 transmits a device information acquisition request in the first protocol, the receiving unit 353 receives a device information acquisition response in the first protocol containing the IP address “192.168.10.11”, the MAC address “BB:BB:BB:00:00:01”, the serial number “B12345”, and the status information such as the count information “4142” and the error information “−” of the device 20, for example, as the device information of the device 20 from the device 20. Thus, the managing unit 354 registers the values of the device information of the device 20 received by the receiving unit 353 in the device information storage unit 341 and sets the value of the connection flag to “0” as illustrated in FIG. 8.

Subsequently, when the connection is switched from the connection in FIG. 1 to the connection in FIG. 2 and the transmitting unit 352 transmits a device information acquisition request in the first protocol, the receiving unit 353 receives a device information acquisition response in the first protocol containing the IP address “192.168.10.10” and the MAC address “AA:AA:AA:00:00:01” of the PC 10, the serial number “B12345” and the status information such as the count information “3928” and the error information “−” of the device 20, for example, as the device information of the device 20 from the PC 10 since the connection of the device 20 is local connection. Thus, the managing unit 354 updates the IP address and the MAC address with the values of the PC 10, additionally registers the status information of the device 20 in the device information storage unit 341 and further updates the value of the connection flag with “1” as illustrated in FIG. 9.

Although the case in which the device 20 is switched from network connection to the local connection has been described in the examples illustrated in FIGS. 8 and 9, the managing unit 354 manages device information in the same manner in a case in which the device 20 is switched from local connection to network connection.

The creating unit 355 creates a report by using the device information of the devices to be managed by the device management device 30 stored in the device information storage unit 341. The created report may be displayed on the display unit 330 or may be output to an external device via the communication unit 310.

The device management device 30 need not include all of the respective units described above as essential components, but some of the units may be excluded.

Next, operation of the device management system according to the embodiment will be described.

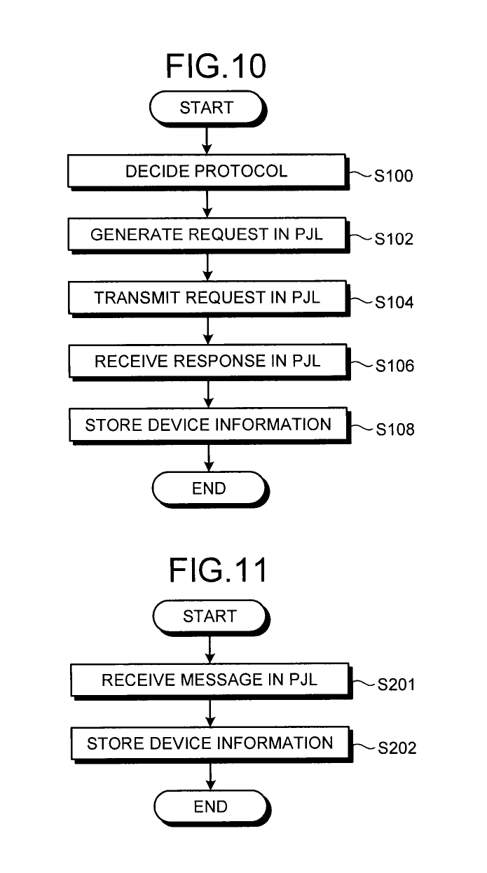

FIG. 10 is a flowchart illustrating an example of processing performed by the PC 10 at activation of the device 20 when the device 20 is connected to the communication interface 3 in the device management system 1 according to the embodiment.

First, when the device 20 connected to the PC 10 via the communication interface 3 is activated, the deciding unit 173 decides a protocol to be used for communication with the device 20 (step S100). In this process, the deciding unit 173 decides a PJL as the protocol to be used for communication with the device 20.

Subsequently, the request generating unit 181 generates a second device information acquisition request that is a request in the PJL decided by the deciding unit 173 and requests acquisition of fixed device information of the device 20 (step S102).

Subsequently, the first transmitting unit 182 transmits the request in the PJL generated by the request generating unit 181 to the device 20 via the communication interface 3 (step S104).

Subsequently, the first receiving unit 183 receives a second device information acquisition response that is a response in the PJL generated by the device 20 and responds with acquisition of the fixed device information of the device 20 from the device 20 via the communication interface 3 (step S106).

Subsequently, the response generating unit 184 converts the fixed device information of the device 20 contained in the response in the PJL received by the first receiving unit 183 into that for the first protocol, and stores the conversion result in the device information storage unit 141 (step S108).

FIG. 11 is a flowchart illustrating an example of processing performed by the PC 10 at occurrence of an error in the device 20 when the device 20 is connected to the communication interface 3 in the device management system 1 according to the embodiment.

First, when an error occurs in the device 20, the first receiving unit 183 receives a device information notification that is a message in the PJL and informs of the error information of the device 20 from the device 20 via the communication interface 3 (step S201).

Subsequently, the response generating unit 184 converts the error information of the device 20 contained in the message in the PJL received by the first receiving unit 183 into that for the first protocol, and stores the conversion result in the device information storage unit 141 (step S202).

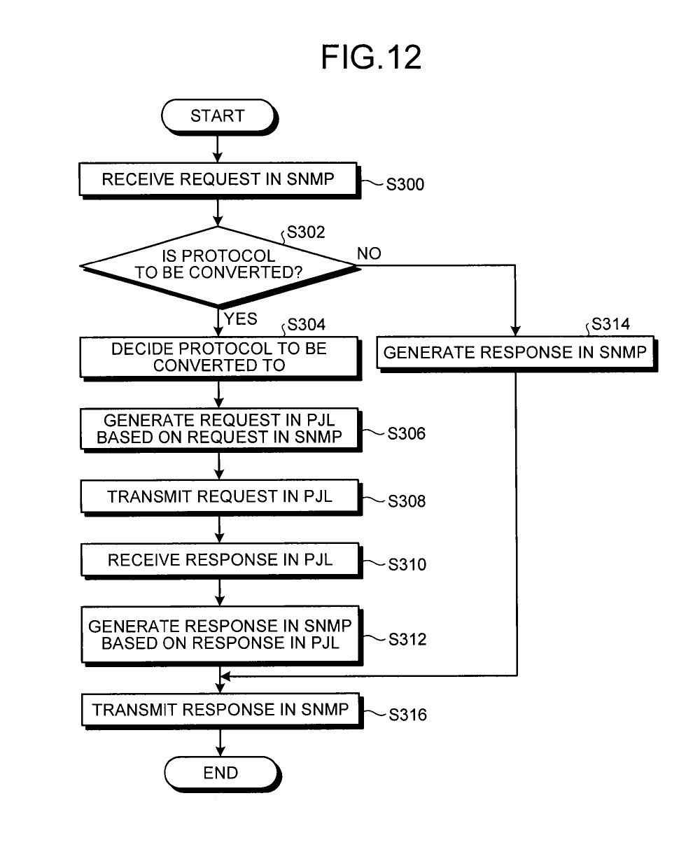

FIG. 12 is a flowchart illustrating an example of processing performed by the PC 10 when device information is requested by the device management device 30 in the device management system 1 according to the embodiment.

First, the second receiving unit 161 receives a device information acquisition request that is a request in the SNMP from the device management device 30 via the network 2 (step S300).

Subsequently, the deciding unit 173 determines whether or not to convert the protocol of the request in the SNMP received by the second receiving unit 161 (step S302).

If the protocol of the request in the SNMP is to be converted (Yes in step S302), the deciding unit 173 decides the protocol into which the request in the SNMP is to be converted by using the model name or the like of the local device stored in the device information storage unit 141 (step S304). In this process, the deciding unit 173 decides the PJL as the protocol to be used for communication with the device 20.

Subsequently, the request generating unit 181 generates a first device information acquisition request that is a request in the PJL decided by the deciding unit 173 and requests acquisition of the device information such as count information of the device 20 on the basis of the request in the SNMP (step S306).

Subsequently, the first transmitting unit 182 transmits the request in the PJL generated by the request generating unit 181 to the device 20 via the communication interface 3 (step S308).

Subsequently, the first receiving unit 183 receives a second device information acquisition response that is a response in the PJL generated by the device 20 and responds with acquisition of the device information such as the count information of the device 20 from the device 20 via the communication interface 3 (step S310).

Subsequently, the response generating unit 184 generates a device information acquisition response containing the device information of the device 20 that is a response in the SNMP on the basis of the response in the PJL (step S312).

If the protocol of the request in the SNMP is not to be converted (No in step S302), on the other hand, the response generating unit 184 generates a device information acquisition response containing the device information of the device 20 that is a response in the SNMP by using the device information of local devices stored in the device information storage unit 141 (step S314). If, however, the protocol of the request in the SNMP is not to be converted because the device 20 is not connected to the PC 10, the response generating unit 184 does not generate the device information acquisition response containing the device information of the device 20 that is a response in the SNMP.

Subsequently, the generating unit 162 generates a device information acquisition response containing the device information of the PC 10 that is a response in response to the request in the SNMP by using the device information of the PC 10 stored in the device information storage unit 141. The second transmitting unit 163 then transmits the response in the SNMP generated by the response generating unit 184 and the response in the SNMP generated by the generating unit 162 to the device management device 30 via the network 2 (step S316).

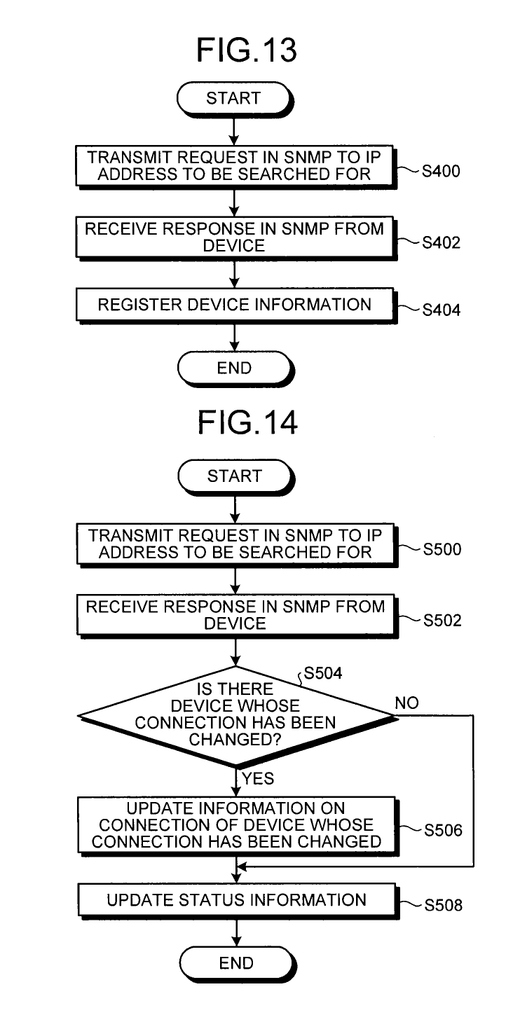

FIG. 13 is a flowchart illustrating an example of a registration process performed by the device management device 30 in the device management system 1 according to the embodiment.

First, the transmitting unit 352 transmits a device information acquisition request that is a request in the SNMP and requests acquisition of device information to an IP address to be searched for via the network 2 (step S400). The IP address to be searched for may be determined in advance or may be specified by a user.

Subsequently, the receiving unit 353 receives a device information acquisition response that is a response in the SNMP and contains the device information of a network device in which the IP address for which the request in the SNMP is transmitted is set from the network device via the network 2 (step S402). When a local device is connected to the network device, the receiving unit 353 receives a device information acquisition response containing the device information of the local device in addition to the device information acquisition response containing the device information of the network device as the response in the SNMP. When there is no network device in which the IP address for which the request in the SNMP is transmitted, the receiving unit 353 does not receive a response in the SNMP.

Subsequently, the managing unit 354 newly registers the device information received by the receiving unit 353 in the device information storage unit 341, and manages the device as the device to be managed by the device management device 30 (step S404).

FIG. 14 is a flowchart illustrating an example of a management process performed by the device management device 30 in the device management system 1 according to the embodiment.

First, the transmitting unit 352 transmits a device information acquisition request that is a request in the SNMP and requests acquisition of device information to an IP address to be searched for via the network 2 (step S500).

Subsequently, the receiving unit 353 receives a device information acquisition response that is a response in the SNMP and contains the device information of a network device in which the IP address for which the request in the SNMP is transmitted is set from the network device via the network 2 (step S502).

Subsequently, the managing unit 354 checks whether or not there is a device whose connection is changed in the device information received by the receiving unit 353 (step S504). For example, if there is no response from the IP address for which the request in the SNMP is transmitted and if a device information acquisition response containing the device information of a device in which the IP address is set is contained in a response from another network device, the managing unit 354 confirms that the connection of the device has been changed from network connection to local connection. For another example, if a device information acquisition response containing the device information of a local device is not contained in a response from a network device in which the IP address for which the request in the SNMP is transmitted and if a device information acquisition response containing the device information of the local device (at this point, however, a network device) is received as a response from a network device for which an IP address has not been set, the managing unit 354 confirms that the connection of the device has been changed from local connection to network connection.

Subsequently, if the device whose connection has been changed is confirmed (Yes in step S504), the managing unit 354 updates information on the IP address, the MAC address, and information on the connection such as the connection flag of the device in the device information stored in the device information storage unit 341 (step S506). If no device whose connection has been changed is confirmed (No in step S504), the managing unit 354 does not perform the process in step S506.

Subsequently, the managing unit 354 additionally registers the status information contained in the device information received from the network device in the device information stored in the device information storage unit 341, and updates the status information of the device information stored in the device information storage unit 341 (step S508).

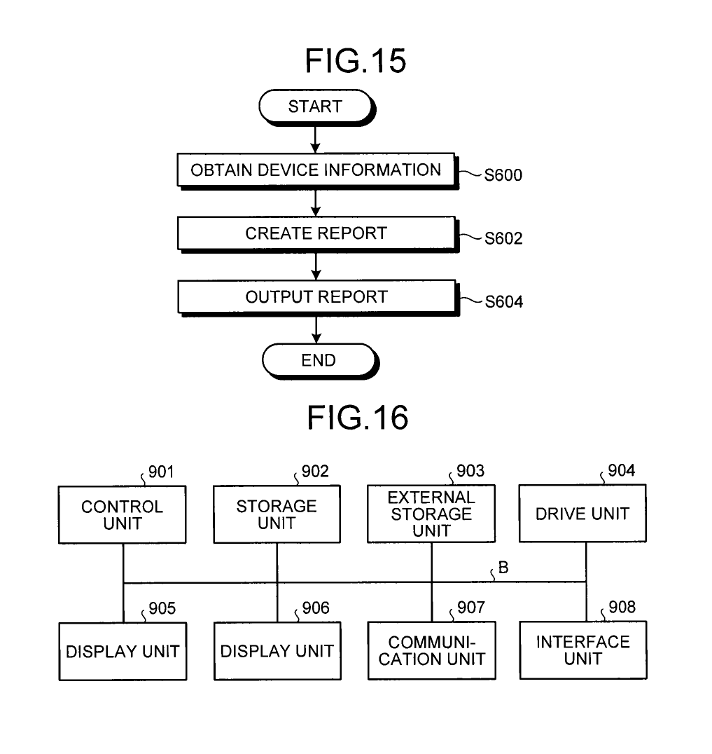

FIG. 15 is a flowchart illustrating an example of a report creation process performed by the device management device 30 in the device management system 1 according to the embodiment.

First, when the creating unit 355 is instructed to create a report by the communication unit 310 or the operating unit 320, the creating unit 355 obtains device information from the device information storage unit 341 (step S600).

Subsequently, the creating unit 355 creates a report by using the obtained device information (step S602).

Subsequently, the creating unit 355 displays the created report on the display unit 330 or outputs the created report to an external device via the communication unit 310 (step S604).

As described above, according to the embodiment, the device management device 30 manages a device to be managed as the same device even when the connection of the device has been changed, which allows continuous management of the device. Accordingly, even in creating a report presenting the management of a device, an accurate report without any missing part or the like can be created.

Note that, with device management systems of the related art, sufficient device information of local devices cannot be acquired because of differences in protocols and the like in management of local devices, and the local devices are thus managed only regarding the presence/absence thereof. In addition, when the connection of a device to be managed is changed, it is difficult to automatically manage the device as one device because of differences in protocols and the like.

In contrast, according to the embodiment, when a device information acquisition request in the first protocol is received from the device management device 30, the PC generates a device information acquisition request in the second protocol used for communication with a local device on the basis of the device information acquisition request in the first protocol, acquires the device information from the local device, and informs the device management device 30 of the acquired device information by means of a device information acquisition response in the first protocol. According to the embodiment, therefore, device information equivalent to that of network devices can also be acquired for local devices that are not connected to a network, which allows the device management device to also perform advanced management of the local devices.

In addition, according to the embodiment, since the fixed device information of local devices is acquired in advance from the local devices, the fixed device information need not be acquired each time from the local devices, which can reduce the communication traffic between the PC 10 and the local devices and improve the processing performance.

Hardware Configuration

FIG. 16 is a block diagram illustrating an example of the hardware configuration of the PC 10 and the device management device 30 according to the embodiment. As illustrated in FIG. 16, the PC 10 and the device management device 30 according to the embodiment each include a control unit 901 such as a CPU, a storage unit 902 such as a ROM and a RAM, an external storage unit such as an HDD and an SSD, a drive unit 904, an input unit 905 such as a mouse and a keyboard, a display unit 906 such as a display, a communication unit 907 such as an NIC, and an interface unit 908, which are connected to one another via a bus B and which can be realized by a hardware configuration utilizing a common computer system.

The agent programs to be executed by the PC 10 of the embodiment and the device management programs to be executed by the device management device 30 of the embodiment are recorded on a computer readable storage medium such as a CD-ROM, a CD-R, a memory card, a digital versatile disk (DVD), and a flexible disk (FD) in a form of a file that can be installed or executed, and provided therefrom.

Alternatively, the agent programs to be executed by the PC 10 of the embodiment and the device management programs to be executed by the device management device 30 of the embodiment may be stored on a computer system connected to a network such as the Internet, and provided by being downloaded via the network. Still alternatively, the agent programs to be executed by the PC 10 of the embodiment and the device management programs to be executed by the device management device 30 of the embodiment may be provided or distributed through a communication network such as the Internet. Still alternatively, the agent programs to be executed by the PC 10 of the embodiment and the device management programs to be executed by the device management device 30 of the embodiment may be embedded in a ROM or the like and provided therefrom.

The agent programs to be executed by the PC 10 of the embodiment and the device management programs to be executed by the device management device 30 of the embodiment have a modular structure for implementing the respective units described above on a computer system. In an actual hardware configuration, the control unit 901 reads the programs from an external storage unit 903 onto the storage unit 902 and executes the programs, whereby the respective units described above are implemented on the computer system.

### Modified Example

Note that the present invention is not limited to the embodiment described above, but various modifications can be made thereto. For example, although the example in which the devices are printing devices is described in the embodiment, the devices may be projectors, for example.

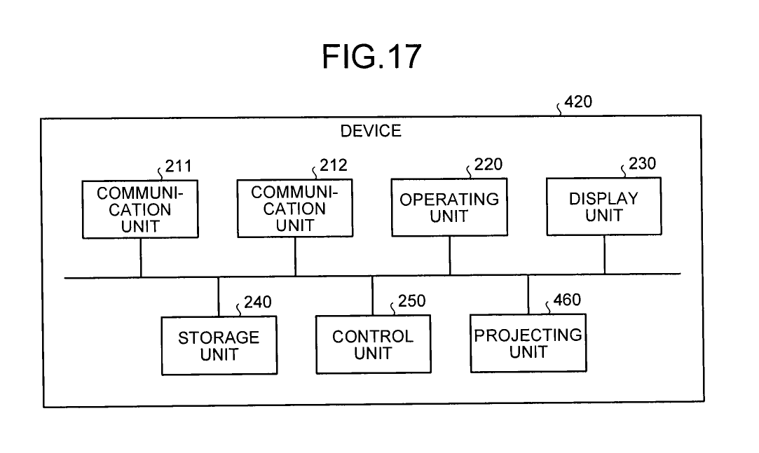

FIG. 17 is a block diagram illustrating an example of the configuration of a device 420 according to a modified example. As illustrated in FIG. 17, the device 420 includes a communication unit 211, a communication unit 212, an operating unit 220, a display unit 230, a storage unit 240, a control unit 250, and a projecting unit 460.

The communication unit 211, the communication unit 212, the operating unit 220, the display unit 230, the storage unit 240 and the control unit 250 are similar to those in the embodiment described above. When the PC 10 requests projection in a PJL, the projecting unit 460 performs projection.

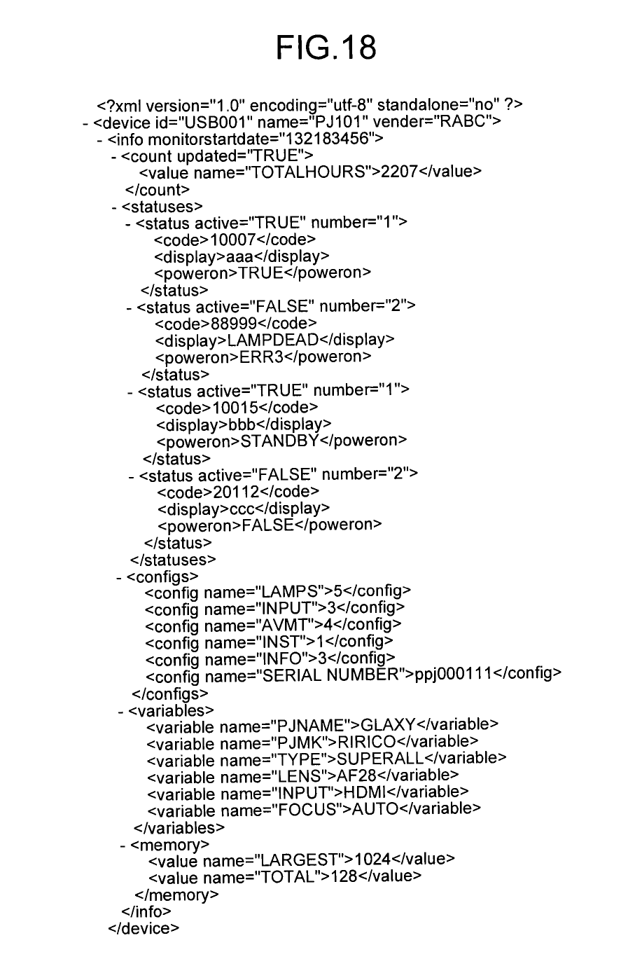

Thus, in the case in which the device 420 is a projector, when the predetermined PJL is decided by the deciding unit 173 as the protocol into which a device information acquisition request in the first protocol is to be converted, the first protocol conversion module 180 of the PC 10 generates @PJL INQUIRE INTRAYXSIZE, PJL INQUIRE INTRAYXQUANT, and @PJL INQUIRE INTRAYXMEDIA as a first device information acquisition request in the predetermined PJL, transmits the generated request to the device 420, receives a response from the device 420, formats the received response in XML data as illustrated in FIG. 18, parses data in a tab “variables” out of the formatted XML data, and converts the parsed data into those for the first protocol.

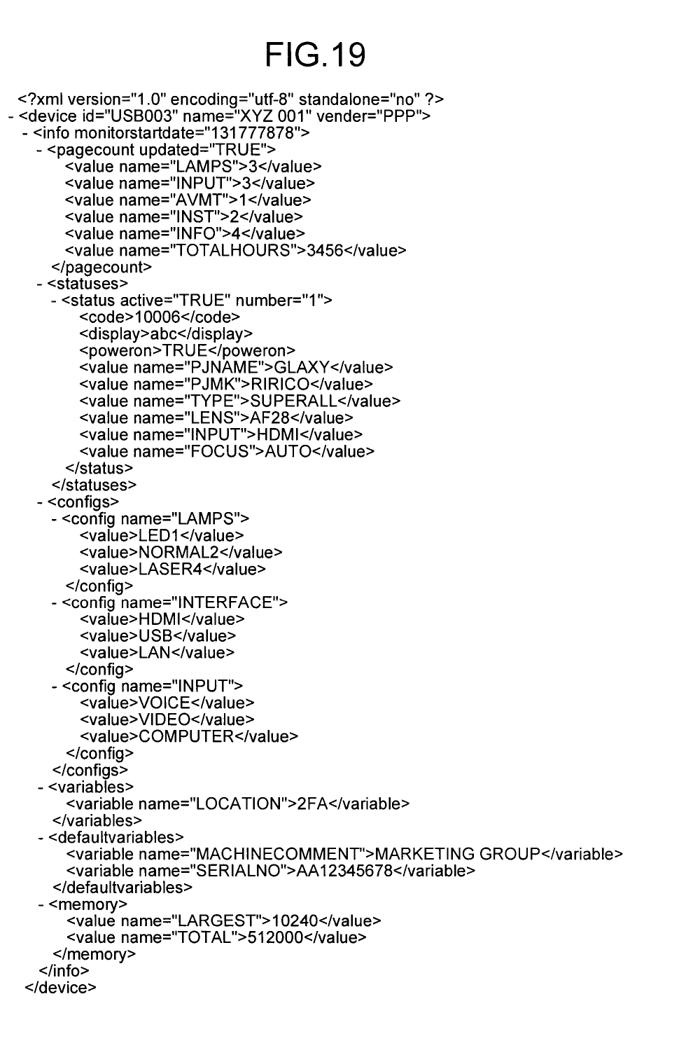

Similarly, when the PJL different from the predetermined PJL is decided by the deciding unit 173 as the protocol into which the device information acquisition request in the first protocol is to be converted, the n-th protocol conversion module 190 of the PC 10 generates @PJL INFO STATUS as a first device information acquisition request in the PJL, transmits the generated request to a local device that is different from the device 420 and connected to the PC 10, receives a response from the local device, formats the received response in XML data as illustrated in FIG. 19, parses data in a tab “statuses” out of the formatted XML data, and converts the parsed data into those for the first protocol.

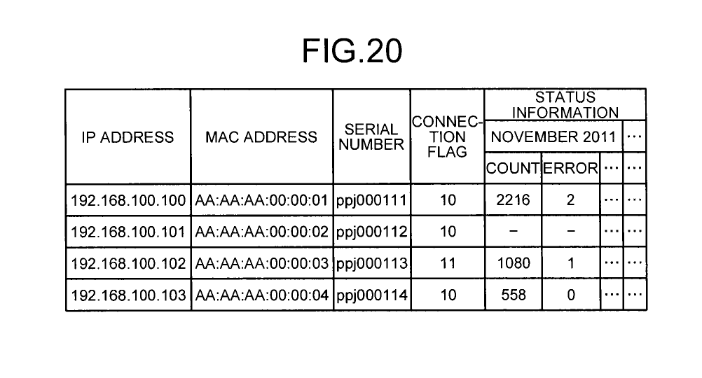

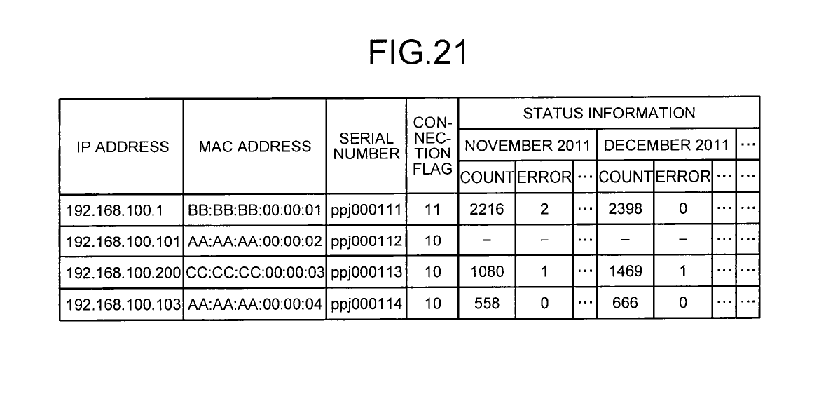

In addition, in this case, the device information stored in the device information storage unit 341 by the managing unit 354 of the device management device 30 is as illustrated in FIGS. 20 and 21, for example. FIG. 20 illustrates the device information of devices under the connection as in FIG. 1, and FIG. 21 illustrates the device information of devices after the connection is switched from the connection as in FIG. 1 to the connection as in FIG. 2.

Note that the device management device 30 may be a single device or a system including a plurality of devices such as a device for managing devices and a device for creating a report, for example.

According to the present invention, an effect that devices can be continuously managed even when connections of the devices are switched is produced.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A device management device connected to a first communication channel, the device management device comprising:
a transmitting part that transmits a device information acquisition request via the first communication channel;
a receiving part that, when a device is connected to the first communication channel, receives a device information acquisition response containing device information of the device from the device via the first communication channel, whereas when the device is connected via a second communication channel to an information processing device connected to the first communication channel, receives a device information acquisition response containing device information of the device acquired by the information processing device from the information processing device via the first communication channel; and
a managing part that stores the device information of the device received from the device and the device information of the device received from the information processing device as device information of the identical device in a device information storage part.

2. The device management device according to claim 1, wherein
the device information storage part stores therein connection information representing connection of the device in association with the device information of the device, and
the managing part updates the connection information when the connection of the device is switched.

3. The device management device according to claim 1, further comprising a creating part that creates a report by using the device information of the device stored in the device information storage part.

4. A device management system comprising a device management device and an information processing device that are connected to a first communication channel, wherein
the device management device includes:
a transmitting part that transmits a first device information acquisition request via the first communication channel;
a receiving part that, when a device is connected to the first communication channel, receives a first device information acquisition response containing device information of the device from the device via the first communication channel, whereas when the device is connected via a second communication channel to the information processing device connected to the first communication channel, receives a first device information acquisition response containing device information of the device acquired by the information processing device from the information processing device via the first communication channel; and
a managing part that stores the device information of the device received from the device and the device information of the device received from the information processing device as device information of the identical device in a device information storage part, and
the information processing device includes:
a control part that, when the device is connected via the second communication channel, transmits a second device information acquisition request based on the first device information acquisition request to the device via the second communication channel, receives a second device information acquisition response containing the device information of the device from the device via the second communication channel, and transmits the first device information acquisition response based on the second device information acquisition response to the device management device via the first communication channel.

5. A computer program product comprising a non-transitory computer-readable medium including a computer-readable program, wherein the program causes a computer to execute:
transmitting a device information acquisition request via the first communication channel;
receiving, when a device is connected to the first communication channel, a device information acquisition response containing device information of the device from the device via the first communication channel, whereas receiving, when the device is connected via a second communication channel to an information processing device connected to the first communication channel, a device information acquisition response containing device information of the device acquired by the information processing device from the information processing device via the first communication channel; and
storing the device information of the device received from the device and the device information of the device received from the information processing device as device information of the identical device in a device information storage part.
